(19) United States
(12) Patent Application Publication
(10) Pub. No.: US 2013/0124364 A1
(43) Pub. Date: May 16, 2013

(54) SYSTEM AND METHOD OF ELECTRONIC PAYMENT USING PAYEE PROVIDED TRANSACTION IDENTIFICATION CODES

(71) Applicant: Millind Mittal, Palo Alto, CA (US)

(72) Inventor: Millind Mittal, Palo Alto, CA (US)

(21) Appl. No.: 13/325,291

(22) Filed: Dec. 14, 2011

Related U.S. Application Data
(60) Provisional application No. 61/559,118, filed on Nov. 13, 2011.

(51) Int. Cl. G06Q 30/06

(52) U.S. Cl. 705/26.41

(57) ABSTRACT

A computerized method of payment based on short, temporary, transaction ID numbers which protect the security of the payer's (customer's) financial accounts. The payee will first register a source of funds and a payer device with a unique ID (such as a mobile phone and phone number) with the invention's payment server. Then once a payee (merchant) and the payer have agreed on a financial transaction amount, the payee requests a transaction ID from the payment server for that amount. The payment server sends the payee a transaction ID, which the payee then communicates to the payer. The payer in turn relays this transaction ID to the server, which validates the transaction using the payer device. The server then releases funds to the payee. The server can preserve all records for auditing purposes, but security is enhanced because the merchant never gets direct access to the customer's financial account information.

### CROSS REFERENCE TO RELATED APPLICATIONS

This application claims the priority benefit of U.S. provisional application 61/559,118, “Per Transaction ID based Payment Method for On-line and in-store Purpose using Mobile Phone”, filed Nov. 13, 2011, inventor Millind Mittal; the contents of which are incorporated herein by reference.

### BACKGROUND OF THE INVENTION

1. Field of the Invention

This invention is in the field of computerized payment methods for commerce and ecommerce.

2. Description of the Related Art

As electronic financial transactions have expanded, exemplified by the widespread use of credit cards for nearly all types of both direct and electronic commerce, so too has the risk of fraudulent financial transactions also expanded. Although much prior effort in security has been devoted to foiling sophisticated “man in the middle” attacks through the use of secure and encrypted communications channels, the simple fact remains that there is almost no defense against low-technology fraud. It is simply all too easy, for example, for an unscrupulous store clerk to write down a customer's credit card number, and then quickly ring up hundreds or even thousands of dollars in unauthorized charges on this card later.

The problem is bad enough when a customer is engaging in face to face transactions at a store counter, but at least there the customer can watch the clerk, and potentially identify the clerk later if necessary. By contrast, when the transaction takes place at a distance, such as by phone or by internet, the customer can't watch the clerk, and has no way at all to identify the clerk.

As a result, many individuals are leery of engaging in long distance electronic financial transactions. Although many financial agencies, such as credit card companies, do have a process for tracking down fraud and reimbursing the customer for fraudulent transactions, the process is slow and painful, as well as adding to the overall financial costs (i.e. overall credit card fees, and the like) to the system.

In an effort to resolve this type of problem, there have been a number of efforts to devise various types of electronic payment systems, exemplified by Paypal and Ericsson IPX mobile payments.

In one such scheme, exemplified by PayPal, the payer (i.e. customer) creates an account with a PayPal network payment server that is generally accessed through the network payment server's client interface (e.g. the PayPal payment server's web browser, or a PayPal linked auction website such as eBay, and the like). The PayPal network payment server then links the payer's account to the payer's credit card, bank account, or other existing source of funds, and also generates a PayPal payee ID (PayPal ID, often based on the payee's email). The payer then pays the payee using his PayPal ID for payment.

The PayPal system is useful for online purchases, but since the PayPal account information (e.g. the user's email, the user's PayPal account ID) continues to be both persistent and sensitive, there are still security concerns. For example, malicious websites which may present a dummy “Paypal look-alike” site for accepting payments. Separately, this system requires entering account information and hence is not as convenient for the user. Furthermore, this system is not suitable for making payments for in-store purchases.

In an alternative approach that is used by some mobile payment services providers, for example Ericsson IPX, to purchase online goods, the payer (i.e. customer) provides a mobile phone number to payee, which then presents the phone number to the Ericcson payment system. The payment system in-turn provides the payer with a short passcode number (PIN). The payer gives this PIN to the merchant (payee). Upon receiving this PIN, the payee (merchant) then releases the on-line goods. The payment funds ultimately come from the payer's mobile phone bill.

The drawback of this approach is payer needs to share his personal information, for example phone number with the payee (merchant) site. Separately this process is bit inconvenient for the payer since he has to first enter information on the payee site and then read PIN from his cell phone, and then enter PIN into payee's online site.

### BRIEF SUMMARY OF THE INVENTION

The invention is based, in part, on the idea that what is needed to facilitate commerce is an alternate method of payment that utilizes a temporary and usually a one-time use transaction “identifier” or code (transaction ID). This transaction ID does allow a payment to be tied to a customer's (payer's) financial information, but does not require that the payer's sensitive financial information be transmitted to a potentially insecure merchant (payee) or other provider of goods and services.

The invention is further based, in part, on the idea that this transaction ID should preferably be short enough to be easily communicated by humans (e.g. a 10 character or less code, rather than a large 30+ character code). As previously discussed this transaction ID should often be good for only a single transaction, and/or be valid for only a relatively limited period of time, such as a week, day, hour, or even minute. Here the shorter the period of time in which the transaction ID is valid, the fewer the number of unique transactions that be supported by this particular transaction ID. This can result in improved convenience for the payer, but of course overly short time periods can also result in inconvenience and an occasional need to repeat valid transactions. This short period can be adjusted to achieve a good tradeoff between security and convenience.

In one embodiment, the invention may be a computerized method of payment based on short, temporary, transaction ID numbers or codes which protect the security of the payer's (customer's) financial accounts. The payer will often initially register a source of funds and a payer device with a unique identification (ID) (such as a mobile phone and phone number) with the invention's payment server. Then once a payee (merchant) and the payer have agreed on a financial transaction amount, the payee can request a transaction ID from the payment server for that amount. The invention's payment server can generate and then transmit (e.g. send by direct electronic transmission, or through one or more intermediate servers) a transaction ID to the payee.

The payee can then provide (communicate) this transaction ID to the payer by a variety of methods (e.g. visual display from a payee device, electronic communication to a payer device, verbal communication between the payee and payer, and so on).

The payer in turn relays (transmits) this transaction ID to the payment server, which then goes through the authorization of the transaction using the payer device. The payment server then releases funds to the payee. The server can also preserve all of these financial transaction details in persistent records for auditing purposes, but nonetheless security is significantly enhanced because the merchant and our hypothetical unscrupulous clerk never get direct access to the customer's financial account information.

In some embodiments, the payee may be willing to accept any of multiple payment services that could be utilized for payments, including transaction ID payments from multiple (different) transaction ID payment servers, possibly run by different organizations. In this case, when the payer is ready to indicate to the payee that it is ready to pay, the payer can also communicate the payer's payment server identifier to the payee. This payment server identifier may, for example, be the name of the payment service associated with the payment server, the network address of the payment server, or other form of identification method suitable for establishing communication between the payee and the payment server. The payee can then use the identified payment server for the transaction.

In some embodiments, the payee request for a transaction ID may be made via an intermediate server. The intermediate server will generally comprise at least one processor, memory, and intermediate server software. In this case, along with the amount to be charged, the payee will often also provide the intermediate server with a payment server identifier.

The payee will typically have a communications device comprising of at least one processor, memory, and payee software. In some embodiments, instead of being connected to the transaction ID payment server through a telecommunications network, the payee's communications device may instead be connected, through the telecommunications network, to an intermediate server that runs a separate payment collection service, running on an intermediate server that is a payment collection server. This payment collection server acts as payee's agent, and it can be separate from the transaction ID payment server. This payment collection server will also generally comprise at least one processor, memory, and payment collection software.

In some embodiments, instead of the payee requesting the transaction ID, the payment collection service itself requests the transaction ID from the payment server. Here the payment collection service essentially acts, on behalf of the payee, as payee's agent to receive the transaction ID. In this case, with respect to the payment server, the payee's agent itself can be viewed as a payee. In this situation, the principal payee for which the agent payee is performing the transaction ID process for may be referred to as the “primary payee”.

Various types of payee agent payment collection services are known in the art. One example of the use of such an intermediate server based, payee agent payment collection service, is when a payee (merchant) offers an option of accepting payment using Paypal as the payment collection service. In this case, Paypal can present the payer with multiple payment options (e.g. use various different credit cards, use Paypal account), and the payer can select one of them for making the payment. Irrespective of which payment method and service the payer selects, Paypal acts as an intermediate (agent) payment collection service on behalf of payee.

According to the invention, the transaction ID method can also be presented by an agent or intermediate payment collection service, such as Paypal, as yet another payment option. When this is done, the request for the transaction ID may be initiated by the payment collection service, and the transaction ID payment server will instead release the payments to the payment collection service. The payment collection service in turn can store the payment on behalf of the payee, or release the payment to the payee.

Using the invention's payee provided transaction ID method and system, consumers can now feel free to order products and services either directly (i.e. face to face, such as in a coffee shop purchase of coffee), or by telecommunications (e.g. phone or internet sales) knowing that the transient transaction ID that is used for this particular financial transaction cannot be used against them for unauthorized purchases.

More specifically, the invention protects the customer's sensitive financial information because the transaction ID is not bound, linked, or otherwise associated with the payer's financial account until the payer enters the transaction ID (usually through a secure communication channel) to the payment server. An additional advantage of this approach is that the payer can further ensure that the payment amount that the payment server releases to the payee for that particular purchase is exactly the payment amount that the payer had previously agreed to pay. This is because the invention's payment server can subsequently obtain electronic authorization from the payer for that specific payment amount. The invention's payment server may also send additional confirmation messages, for example a confirmation email to the payer's email address, at the conclusion of the transaction as well.

One of the benefits of the invention is that, relative to prior art methods, the payer user experience is often simpler and more convenient. This is because, according to the invention, once the transaction ID is provided by the payee (merchant), the payer's (customer's) subsequent steps of submitting the transaction ID, as well as the payer's subsequent validation of the transaction, can be both done in sequence on the payer's device, without the need for the payer to have any intervening interaction with the payee.

Although the transaction ID thus protects the payer's identity and financial accounts to a much greater extent than prior art methods, the invention's payment server can nonetheless also comply with all relevant financial regulations regarding the traceability of financial transactions. This is because the payment server will still contain complete records of the payer's (customer's) identification, the payee (merchant's) identification, as well as the funding amounts, the time of the transaction, and the source of funds used.

Thus to summarize, the present invention provides the very high degree of payer security that results when a transaction can be completed without providing either access or knowledge of the highly sensitive and confidential payer information to the payee (merchant).

### BRIEF DESCRIPTION OF THE DRAWINGS

FIG. 1 shows an overview of the interactions between a payee (such as a merchant), a payer (such as the customer), the invention's transaction ID based payment server, and optional third party funding sources such as banks or credit cards.

FIG. 1A shows an alternate embodiment in which the purchase telecommunications device is different from the default telecommunications device, and/or in which manual payments are made.

FIG. 2 shows how a source of payer funds, such as a particular payer credit card, can be linked or associated with a device that the payer has, such as a mobile phone, which will typically be identified by a unique payer device ID such as the payer's mobile phone number.

FIG. 3 shows a payee (e.g. merchant), selling products or services such as a widget for $5.98. Once the payer (e.g. customer) indicates an interest in the widget and desire to pay by transaction ID, the payee contacts the invention's payment server, indicates the widget amount (e.g. $5.98), and requests a specific transaction ID for that amount. The payment server then generates this transaction ID and sends it to the payee.

FIG. 4 shows how the payer (e.g. customer) after receiving the transaction ID from the payee (e.g. a merchant) can then transmit the transaction ID to the invention's payment server, and then confirm the transaction using the payer's previously identified and validated device (e.g. mobile phone). At this point, the payment server will now have enough information to complete the transaction.

FIG. 5 shows how the payment server, optionally in conjunction with one or more third party funding sources such as banks or credit cards, can then authorize the transaction and begin the process of transferring payer (customer) funds to the payee (merchant).

### DETAILED DESCRIPTION OF THE INVENTION

As previously discussed, one embodiment, the invention may be a computerized method of payment based on short, temporary, transaction ID numbers which protect the security of the payer's (customer's) financial accounts. The payee will first register a source of funds and a payer device with a unique ID (such as a mobile phone and phone number) with the invention's payment server. Then once a payee (merchant) and the payer have agreed on a financial transaction amount, the payee requests a transaction ID from the payment server for that amount. If this payee request for a transaction ID is made via an intermediate server, the payee, along with the amount to be charged, will usually also transmit the payment server identifier to the intermediate server. The payment server sends the payee a transaction ID, which the payee then provides (communicates) to the payer. The payer in turn relays this transaction ID to the payment server, which validates the transaction using the payer device. The payment server then releases funds to the payee. The payment server can preserve all records for auditing purposes, but security is enhanced because the merchant never gets direct access to the customer's financial account information.

If the request for a transaction ID is made by payment collection service linked to the payee device, then after the validation of the transaction using the payer device, the payment server can release the payment to payment collection service, which as previously discussed can either keep or store the payments on behalf of the payee, or in turn release the payment to the payee.

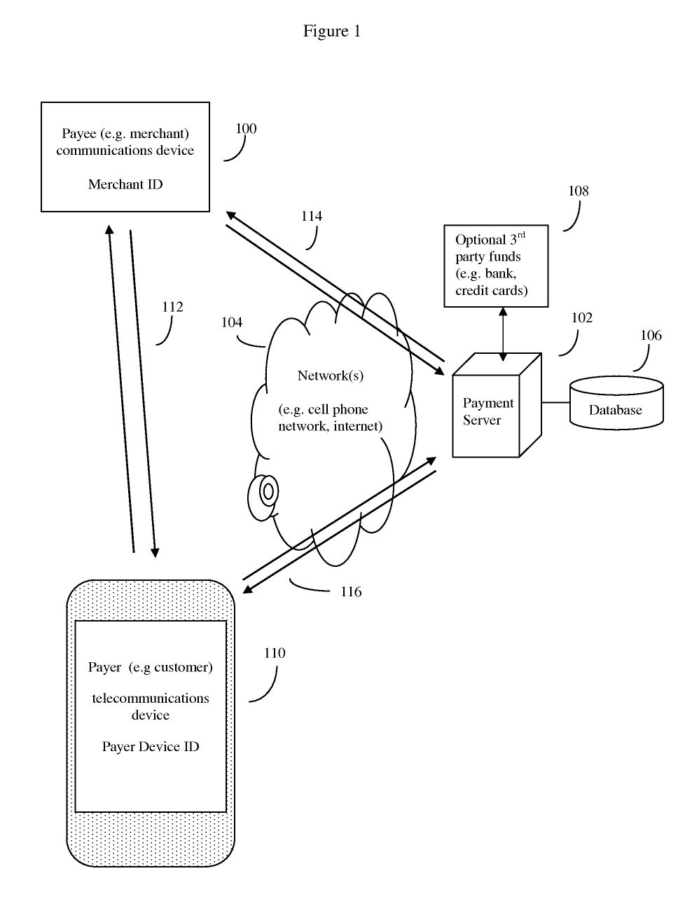

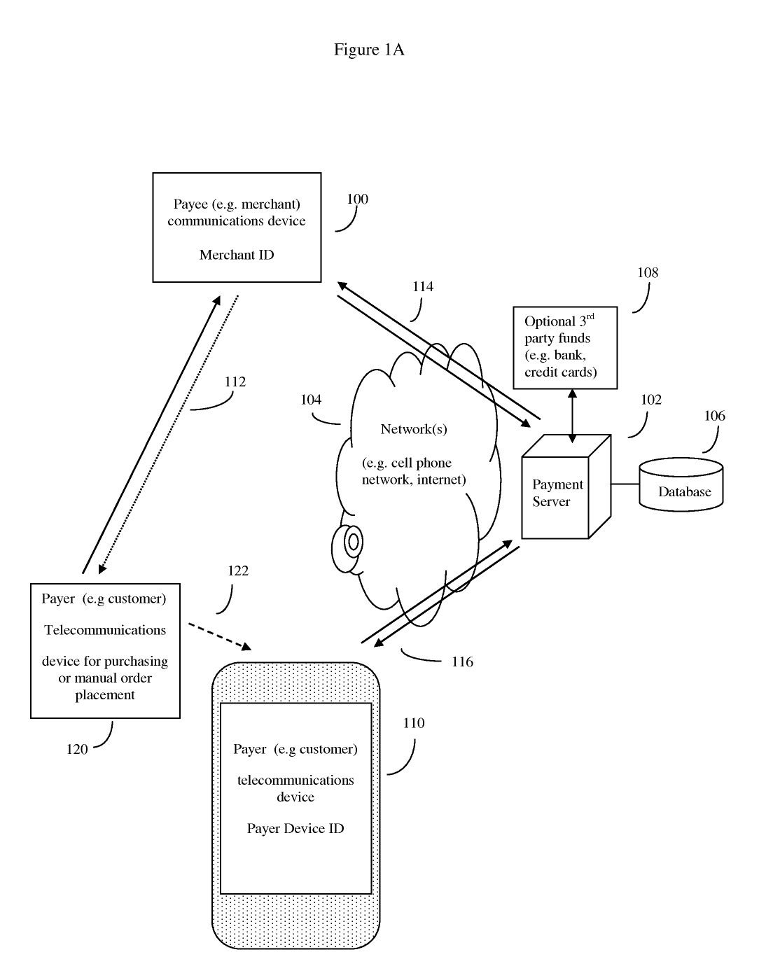

FIG. 1 shows an overview of the interactions between a payee (such as a merchant), a payer (e.g. customer), and the invention's payment server. The payee will have a payee communications device, such as a simple dumb phone, mobile phone (basic feature phone or a smartphone), tablet computer, desktop computer, laptop computer or other device (100). This payee communications device (100) is capable of establishing a connection to the invention's payment server (102) using one or more networks, using either standard phone lines, mobile phone connections, or the Internet as well as private networks and/or all combinations of such networks (104).

Thus in more detail, the payee communications device could be as simple as a “dumb” landline phone that connects to the invention's payment server (102) via a voice connection, or alternatively a more sophisticated communications device equipped with a processor (e.g. microprocessor), memory, and software, such as a mobile phone, smartphone, handheld computer, tablet computer, desktop computer, or laptop computer. The communications device may also have a web browser, and some or all of the transaction may take place by the web browser. The main criteria for communications device (100) is that it be capable of being linked to a unique merchant identification (ID) so that the invention's payment server can verify the identity of the payee who is using communications device (100).

The invention's payment server (102) will often comprise one or more processors (e.g. microprocessors), memory (e.g. RAM, Flash memory), software, network connection devices, and persistent memory storage such as disk drives or other persistent memory device used for database purposes (106). The payment server (102) may access this persistent memory storage (106) using standard database software (e.g. MySQL) or custom database software as desired.

Payment server (102) may also be a web server, in which case it will also run web server software such as Apache and the like, often assisted with various types of scripting software (e.g. Ruby, Perl and the like), and serve web pages suitable for payer and payee interaction.

Payment server (102) may also have other devices, such as speech recognition and speech synthesis devices, to facilitate audio communication when such audio communication is desired.

Payment server (102) will often be connected to optional third party sources of funding and/or credit verification (108). These third party sources can include various banks, credit card companies, and other traditional or non-traditional sources of funds that may potentially be used for the various financial transactions. If the organization that runs the payment server (102) is itself equipped with adequate financial resources, then the optional third party sources (108) need not be used, or alternatively may be replaced by credit rating agencies and the like.

The third leg of the system is the payer (e.g. the customer), who will generally interact with the system using a payer telecommunications device (110). This device (110) will often be a mobile phone, smartphone, tablet computer, laptop computer, desktop computer, or other computerized device capable of storing a unique identification token, and/or equipped with a payer biometric sensor (e.g. fingerprint sensor). In a preferred embodiment, this device (110) is a mobile phone or smart phone that will preferably be capable of sending and receiving Short Message Service (SMS) and/or text messages. The payer telecommunications device (110) will generally be capable of at least establishing a network connection with the invention's payment server (102), and often (but not necessarily always) with the payee communications device (100) also.

Note that it is contemplated that some or all of the invention's methods will be implemented in the form of computer software running on payment server (102), and the description in this specification may be viewed as being a functional description of the various actions and software implemented methods that the payment server will implement according to the invention. Thus in one embodiment, all of the custom functionality of the invention may be implemented on payment server (102). In this case, payee computerized device (100) and payer telecommunications device (110) may simply interact with the invention's software running on payment server (102).

In other embodiments, the invention's methods may also be implemented in part through the use of custom applications software (e.g. apps) running on devices such as payer telecommunications device (110) or even payee communications device (100). Additionally, when payee communication device (100) is a web server, it may serve web pages intended to run under the control of processor(s) in devices (110) and/or (100), which may perform various functions such as display of transaction ID's, data input, control of biometric sensors, and the like.

Note that communications between the payee (100) and the payer (110) need not be either machine based or pass over a communications network, although they may be. Here any method of communicating information (112), ranging from wireless, infrared, electronic, optical and audio methods up to and including talking, writing, pointing, sign language, or even carrier pigeon, drum beats, or smoke signals can be used. In some embodiments, such as when a customer is talking to a clerk at a check-out counter, the communications (e.g. the exchange of transaction ID) between the customer using device (110) and the merchant (using device 100) can be verbal or written. Thus a simple verbal statement: “The transaction ID is 352431 for your purchase” can be sufficient for communications link (112), and link (112) need not be over a network (104), although it may be. Alternatively the merchant payee (100) may use a customized device, such as a modified terminal or cash register, that displays the transaction ID directly, which the customer can then observe and enter in to his own device (110). By contrast, communications to and from the payment server (102) will generally proceed by a network such as (104) for both communications device (100) (e.g. 114) and communications device (110) (e.g. 116).

Thus, more specifically, in one embodiment, the invention may be a transient transaction ID method of payment, comprising a payment server (102) connected to a telecommunications network (104). This payment server will generally comprise at least one processor, memory, and payment software. As previously discussed, this payment server will generally be linked to at least one payment source such as 3^{rd} party source (108), or alternative source of funds.

The invention will also generally require that there be at least one payer telecommunications device (110) connected to the telecommunications network (104).

Usually, before a transaction of interest commences, some preliminary steps will be performed. One step is the step of using the payer's telecommunications device (110) to communicate with the payment server (102) and inform the server that a payer source of funds (e.g. a payer credit card number, bank account, or the like) should be linked to the device ID of the payer's telecommunication's device (110).

FIG. 1A shows an alternate embodiment in which the purchase telecommunications device (120) may be different from the default telecommunications device (110), and/or in which electronic payments are made. Here for example, the payer may be communicating with the merchant over a land line telephone or using a web browser on an alternate device (120), receiving the transaction ID from the payee (112) using that alternate device (120), and then providing (communicating) the transaction ID to payer, which the payer then relays (122) to the payer's telecommunication's device (110).

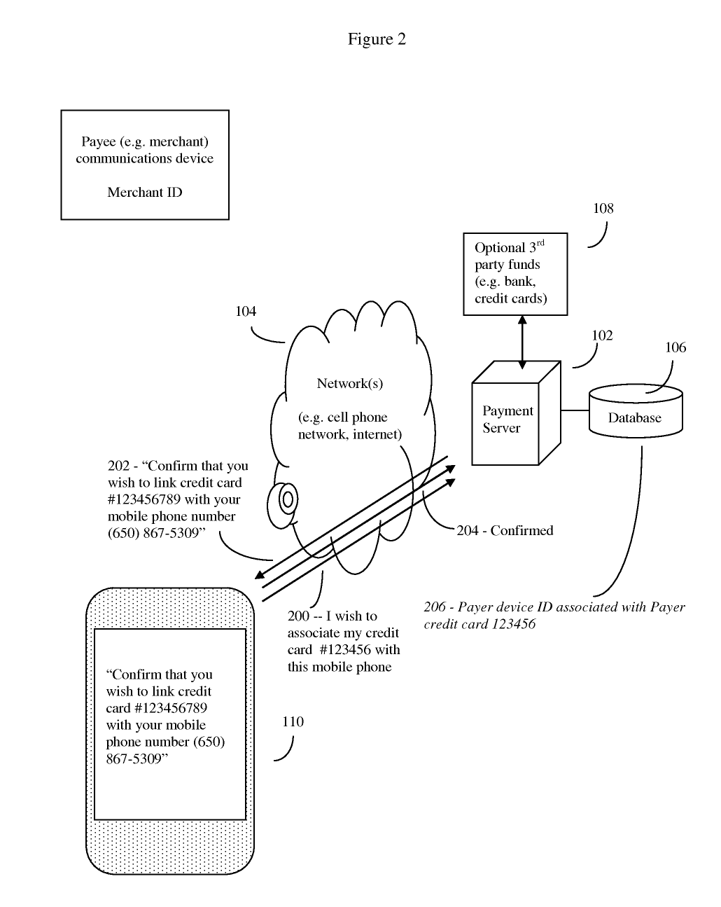

FIG. 2 shows how a source of payer funds, such as a particular payer credit card, can be linked or associated with the payer's telecommunications device (110). When device (110) is a mobile phone, it may conveniently be identified by a unique payer device ID such as the payer's mobile phone number. As previously discussed, alternative payer ID's such as the payer biometric signatures (e.g. fingerprints) can also be used, and here for simplicity such alternative schemes will also be designated as a payer device ID. The larger idea is simply to link a payer financial account with something that the payer has, be it device or be it a payer biometric signature or other payer object.

To do this linkage, the payer can use device (110) to contact the invention's payment server (102), and communicate both the payer's device ID and the payer's financial account number (e.g. credit card number) to the payment server (102), which will in turn store this information in its database (106). Thus for example, in the case where the payer is using a mobile telephone or smartphone, the payer can use either an application running on the smartphone, SMS messaging, text messaging, or even voice messaging (using caller ID) to transmit, for example, “I wish to associate my credit card #123456 with this mobile phone” (200). The payment server in turn indicate that it has received this request (202) “Confirm that you wish to link credit card #123456789 with your mobile phone number (650) 867-5309”, optionally check to ensure that funds are actually available with 3^{rd} parties (108), and often upon receiving a final confirmation from the user (204) then store this association between the payer's telecommunication device and the payer's funding account in database (106) as (206).

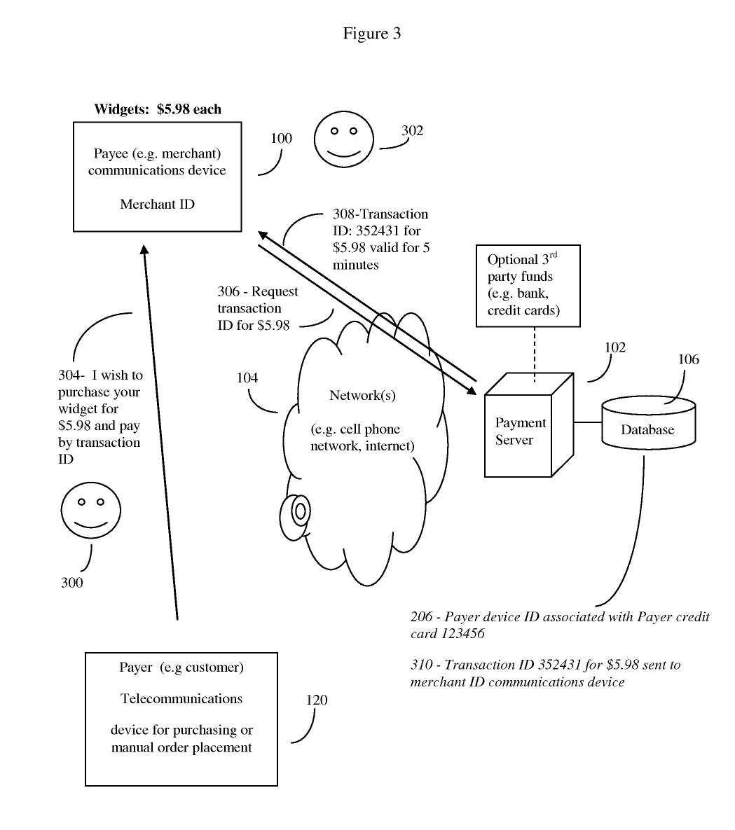

Additionally (not shown) prior to initiating the transition ID based financial transaction, the (e.g. FIG. 3 payer (300) and the payee (302)) will presumably have conducted preliminary negotiations regarding the item or service to be purchased, and the price of the item or service. These preliminary negotiations need not be done using any sort of device at all (although devices (100), (110), (120) may be used). Thus for example, payer (300) could simply speak directly to a merchant/payee (302) at a counter, and accept the merchant's bid for the $5.98 widget by direct verbal offer such as (304), “I wish to purchase your widget for $5.98 and pay by transaction ID”. Alternatively the payer can accept the offer by other means, such as by clicking on an item on a merchant website.

For example, assume that a payee (e.g. a merchant) (100) is selling a “widget” for $5.98. (Here the term widget can mean either goods or services).

This is shown in FIG. 3. Once the payer (e.g. customer) indicates an interest in the widget and desire to pay by transaction ID, the payee (100) contacts the invention's payment server (102), indicates the widget amount (e.g. $5.98), by a voice or machine message such as (306), “Request transaction ID for $5.98”. The payment server (102) will generate a transaction ID for this, such as (308) “Transaction ID: 352431 for $5.98 valid for 5 minutes” and transmit this back to the payee device (100). The payment server (102) will also save a record of the transaction ID number, the payment amount, and the merchant ID in its database (106) as (310).

As previously discussed, this transaction ID is preferably a transient (i.e. one time use, limited time use, or both) transaction ID that may in a preferred embodiment be relatively short (e.g. 10 alphanumeric characters in length or shorter) and intended for convenient manual or spoken data entry by unskilled users. Generally the transaction ID will be intended for one-time use only within the time window in which the transaction ID is valid. The length of this time window may be determined as desired by the system operators, with a time duration in which the transaction ID is valid on the order of weeks, days, hours, or even minutes (e.g. 1 minute, 5 minutes, 1 hour, 1 day, 1 week and so on). In a preferred embodiment, this transient transaction ID may be generated in a manner (e.g. randomly selected) that does not provide any hints to the actual payee financial account (e.g. credit cards) number. Indeed note that in many embodiments, the transaction ID will be generated by payment server (102) before the payment server even knows who the payer is.

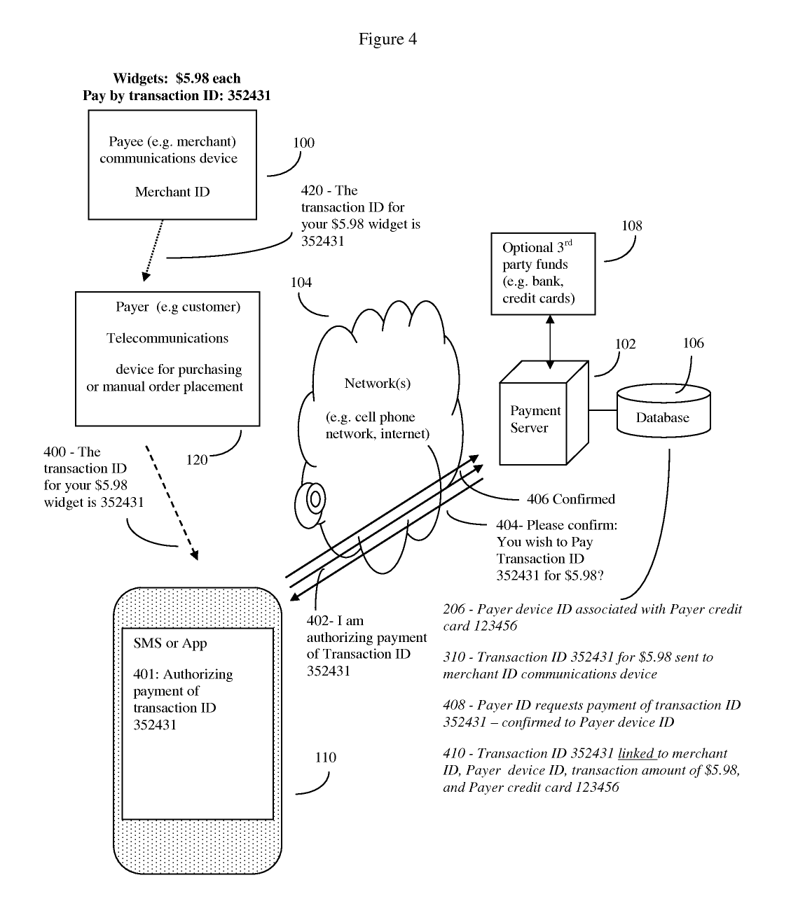

FIG. 4 shows how the payer (e.g. customer) (110) after receiving the transaction ID from the merchant (100) (by any communications means, for example by reading the displayed transaction ID on a communication application portal running on payee device (100), by direct contact, or other method) (e.g. (400)/(420), or via (120), (420), to (400) can then transmit the transaction ID (402) to the invention's payment server (102), often via the payer's telecommunications device (110), (401)). Once the payment server (102) requests confirmation (404), the payer can then confirm (406) the transaction using the payer's previously identified and validated telecommunications device (e.g. mobile phone) (110). At this point, the payment server (102) will now have enough information (408), (410) in its database (106) to complete the transaction.

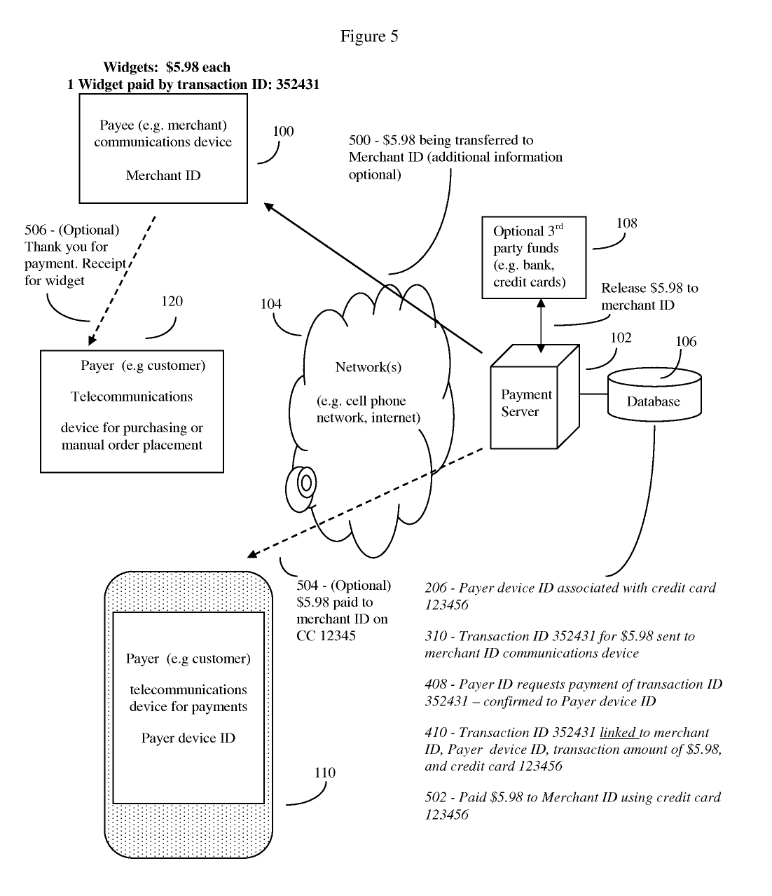

FIG. 5 shows how the payment server (102), optionally in conjunction with one or more third party funding sources such as banks or credit cards (108), can then authorize the transaction and begin the process of transferring (500) payer (customer) funds (110/300) to the payee (merchant) (100/302). The payment server can then record this payment in its database (106), (502), and also generate and send optional confirmation messages (504). The payee (100/302) in turn can also optionally send additional confirmation messages (506) to the payer (110/300) as well, either directly to telecommunications device (110), or alternatively to other devices (120).

Again the payment source for the transferred funds may be a 3^{rd} party payment source (106) or the organization running the payment server (102) may elect to provide the funds directly without use of a third party.

Once either the transaction has completed, and/or the allocated time period (e.g. 1 minute, 1 hour, 1 day, 1 week, 1 month) for the transaction ID to be valid has expired, the transaction ID used for this transaction will become invalid and will no longer be honored by the payment server (102). Thus the payer has the assurance that additional unauthorized transactions will not be occurring, and additionally has completely hidden his or her normal financial account information from the payee (merchant), thus additionally reducing the chances of fraud.

As previously discussed, the payment server (102) will then persistently store this transaction information in its database (106) in order to comply with various financial regulations and statutes. This persistently stored information will generally consist of at least the identification information pertaining to said payee, identification information pertaining to said payer, time of transaction, said payment amount, and said transient transaction ID. This allows the complete financial transaction to be later retrieved and audited by authorized individuals and agencies as needed.

1. A transient transaction ID method of payment, comprising:
a payment server connected to a telecommunications network, said payment server comprising at least one processor, memory, and payment software, said payment server being linked to at least one payment source;
at least one payer telecommunications device connected to said telecommunications network;
and at least one payee desiring a payment amount from said payer for a transaction, said payee being connected to said payment server by a payee communications device connected to said telecommunications network;
wherein said payee transmits said payment amount to said payment server and requests said payment server generate a transient transaction ID for said transaction;
said transient transaction ID being a short numeric or alphanumeric code that is valid for either a single transaction or a limited time period;
said payment server generates said transient transaction ID and transmits said transient transaction ID to said payee;
said payee provides said transient transaction ID to said payer;
said payer transmits said transient transaction ID to said payment server using said payer telecommunications device;
said payment server receives said transient transaction ID from said payer, and transmits an authorization request to said payer telecommunications device, said authorization request comprising at least said payment amount, and a request for authorization;
said payer receives said authorization request and transmits back an authorization to said payment server;
wherein if said payment server receives said authorization prior to the end of said limited time period, said payment server uses said at least one payment source to send said payment amount to said payee.

2. The method of claim 1, wherein said telecommunications device is a mobile phone capable of sending and receiving SMS and/or text messages.

3. The method of claim 1, wherein said computerized device or telecommunications device is computerized device, said computerized device comprising at least one processor, memory, and software.

4. The method of claim 3, wherein said computerized device or telecommunications device is a mobile phone, handheld computer, tablet computer, desktop computer, or laptop computer.

5. The method of claim 3, wherein said computerized device or telecommunications device has a web browser, and at least some of said transaction is conducted using said web browser.

6. The method of claim 1, wherein said payment server is a web server.

7. The method of claim 1, wherein said transaction ID is a numeric or alphanumeric sequence of 10 characters or less.

8. The method of claim 1, wherein said limited time period is one week or less.

9. The method of claim 1, wherein said payment server persistently stores identification information pertaining to said payee, identification information pertaining to said payer, time of transaction, said payment amount, and said transient transaction ID in a database so that information pertaining to said transaction can be subsequently retrieved for audit purposes.

10. The method of claim 1, wherein said payee is an intermediate server or payment collection server acting as the agent for a primary payee.

11. The method of claim 1, wherein there are a plurality of payment servers, each said plurality of payment servers having its own identifier, and in which said payer also transmits the identity of one of said plurality of payment servers to said payee, and said payee uses this identity to perform the method of claim 1 with the identified payment server.

12. A transient transaction ID method of payment, comprising:
a payment server connected to a telecommunications network, said payment server comprising at least one processor, memory, and payment software, said payment server having a payment server identifier and being linked to at least one payment source;
a payment collection service connected to said payment server by a payment collection server connected to said telecommunications network;
said payment collection server comprising at least one processor, memory, and payment collection software;
at least one payee desiring a payment amount from a payer for a transaction, said payee being connected to said payment collection service by a payee communications device connected to said telecommunications network;
whereby said payee is able to communicate to said payment collection service;
at least one payer telecommunications device connected to said telecommunications network;
said payer desiring to pay using said payment server
wherein said payment collection service requests said payment server to generate a transient transaction ID for said transaction;
said transient transaction ID being a numeric or alphanumeric code that is valid for a either a single transaction or a limited time period;
said payment server generates said transient transaction ID and transmits said transient transaction ID to said payment collection service;
said payment collection service provides said transient transaction ID to said payer;
said payer transmits said transient transaction ID to said payment server using said payer telecommunications device;
said payment server receives said transient transaction ID from said payer, and transmits an authorization request to said payer telecommunications device, said authorization request comprising at least said payment amount and a request for authorization;
said payer receives said authorization request and transmits back an authorization to said payment server;
wherein if said payment server receives said authorization prior to the end of said limited time period, said payment server uses said at least one payment source to send said payment amount to said payment collection service.

13. The method of claim 12, wherein said computerized device or telecommunications device is a mobile phone, handheld computer, tablet computer, desktop computer, or laptop computer.

14. The method of claim 13, wherein said authorization request is transmitted from said payment server to the mobile phone of said payer, and said authorization is transmitted from said payer to said payment server using said mobile phone, by using SMS messaging and/or text messaging.

15. The method of claim 13, wherein prior to said transaction, said payer uses said mobile phone to communicate with said payment server, register said mobile phone with said payment server, and also communicate at least one payment source to said payment server.

16. The method of claim 13, wherein said mobile phone is a smartphone and wherein at least some of said transaction is handled by an app running in said smartphone.

17. The method of claim 16, wherein said payment server transmits said payment amount and said authorization request to said app;
said payer enters said transaction ID and authorization into said app;
and said app transmits said transaction ID and authorization to said payment server.

18. The method of claim 16, wherein said app is further authenticated to said payment server by way of a personal identification number (PIN).

19. The method of claim 12, wherein said transaction ID is a numeric or alphanumeric sequence of 10 characters or less.

20. The method of claim 12, wherein said limited time period is one week or less.

21. The method of claim 12, wherein said payment server persistently stores identification information pertaining to said payee, identification information pertaining to said payer, time of transaction, said payment amount, and said transient transaction ID in a database so that information pertaining to said transaction can be subsequently retrieved for audit purposes.

22. A transient transaction ID method of payment, comprising:
a payment server connected to a telecommunications network, said payment server comprising at least one processor, memory, and payment software, said payment server having a payment server identifier, and said payment server being linked to at least one payment source;
an intermediate server connected to a telecommunications network, said intermediate server comprising at least one processor, memory, and intermediate server software;
at least one payer mobile phone, capable of sending and receiving SMS and/or text messages, connected to said telecommunications network;
at least one payee desiring a payment amount from said payer for a transaction, said payee being connected to said intermediate server by a payee communications device connected to said telecommunications network;
and a payer desiring to pay using said payment server;
wherein said payee transmits said payment amount and said payment server identifier to said intermediate server;
wherein said intermediate server requests said payment server generate a transient transaction ID for said transaction;
said transient transaction ID being a numeric or alphanumeric code that is valid for either a single transaction or a limited time period, and not otherwise containing any payee identification information;
said numeric or alphanumeric code being 10 characters or less;
said limited time period being one week or less;
said payment server generates said transient transaction ID and transmits said transient transaction ID to said payee;
said payee provides said transient transaction ID to said payer;
said payer transmits said transient transaction ID to said payment server using said payer mobile phone;
said payment server receives said transient transaction ID from said payer, and transmits an authorization request to said payer mobile phone, said authorization request comprising at least said payment amount and a request for authorization;
wherein said authorization request is transmitted from said payment server to the mobile phone of said payer, and said authorization is transmitted from said payer to said payment server using said mobile phone, by using a mobile application or SMS messaging and/or text messaging;
said payer receives said authorization request and transmits back an authorization to said payment server;
wherein if said payment server receives said authorization prior to the end of said limited time period, said payment server uses said at least one payment source to send said payment amount to said payee; and
wherein said payment server persistently stores identification information pertaining to said payee, identification information pertaining to said payer, time of transaction, and transient transaction ID in a database so that information pertaining to said transaction can be subsequently retrieved for audit purposes.
